(19) United States
(12) Patent Application Publication
(10) Pub. No.: US 2009/0079818 A1
(43) Pub. Date: Mar. 26, 2009

(54) STEREOSCOPIC IMAGE DISPLAY APPARATUS AND STEREOSCOPIC IMAGE DISPLAY METHOD

(76) Inventors: Tatsuo SAISHU, Tokyo (JP); Kazuki Taira, Tokyo (JP); Ayako Takagi, Yokosuka-Shi (JP); Masako Kashiwagi, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/233,163

(22) Filed: Sep. 18, 2008

(30) Foreign Application Priority Data
Sep. 25, 2007 (JP) 2007-246984

(51) Int. Cl. H04N 13/00

(52) U.S. Cl. 348/51

(57) ABSTRACT

It is made possible to provide a stereoscopic image display apparatus capable of preventing a luminance difference from being caused between left and right eyes irrespective of the observation position even if the viewing zone is wide and the number of parallaxes is large. A stereoscopic image display apparatus includes: a display unit including pixels arranged in a matrix form in a longitudinal direction and a lateral direction; an optical plate installed so as to be opposed to the display unit and having linear optical openings prolonged in a longitudinal direction and arranged in a lateral direction; and a luminance compensation processing unit which, for each of elemental images associated with the optical openings, sets a brightness of an image displayed on a pixel located in a center of the elemental image smaller than a brightness of an image displayed on a pixel located in each of boundaries of the elemental image.

### CROSS-REFERENCE TO RELATED APPLICATION

This application is based upon and claims the benefit of priority from prior Japanese Patent Application No. 2007-246984 filed on Sep. 25, 2007 in Japan, the entire contents of which are incorporated herein by reference.

### BACKGROUND OF THE INVENTION

1. Field of the Invention

The present invention relates to a stereoscopic image display apparatus and a stereoscopic image display method.

2. Related Art

As for a stereoscopic image display apparatus capable of displaying a moving picture, i.e., the so-called three-dimensional display, various schemes are known. In recent years, demand especially for a scheme that uses a flat panel type and that does not need dedicated glasses is increasing. As for a scheme utilizing the principle of holography among stereoscopic moving picture display apparatuses of this type, realization of full color moving pictures is difficult. However, a scheme of installing an optical plate, which controls a light ray emitted from a display panel and which directs the light ray to a viewer, immediately before a display panel (display apparatus) fixed in pixel position, such as a direct view or projection type liquid crystal display apparatus or plasma display apparatus, can be implemented with comparative ease.

Typically, the optical plate is also called parallax barrier. The optical plate controls the light ray so as to make different images seen depending upon the angle even if the position on the optical plate is the same. Specifically, when only lateral parallax (horizontal disparity) is given, a slit or a lenticular sheet (cylindrical lens array) is used. When vertical parallax (vertical disparity) is also included, a pinhole array or a lens array is used. Schemes using the parallax barrier are also further classified into binocular, multiview, super-multiview (super-multiview condition of multiview), and integral photography (hereafter referred to as IP as well). A basic principle of them is substantially the same as that used in a stereoscopic photograph invented approximately 100 years ago.

Among them, the IP scheme has a merit that the degree of freedom in the viewing point position is high and stereoscopic viewing can be conducted with ease. In the one-dimensional IP scheme having only a horizontal disparity and having no vertical disparity, a display apparatus having a high resolution can also be implemented with comparative ease as described in SID04 Digest 1438 (2004). On the other hand, the binocular and multiview schemes have a problem that the range of the viewing point position from which stereoscopic viewing can be conducted, i.e., the viewing zone is narrow and it is hard to view. However, it is the simplest in the configuration as a stereoscopic image display apparatus and the display image can be formed simply.

In such a direct view type stereoscopic image display apparatus using a slit array or a lenticular sheet, the luminance becomes high as the parallax position approaches the center because of viewing angle characteristics of a display unit such as a liquid crystal panel, an incidence angle to a lens, and a lens aberration, resulting in a luminance difference between left and right eyes when viewed from places other than the strict front of the screen. In the binocular system, this problem does not occur because the viewing zone is restricted to the front of the screen. In the IP scheme and the multiview scheme having a wide viewing zone and a large number of parallaxes, however, this problem occurs.

As described above, the conventional stereoscopic image display apparatus having a wide viewing zone and a large number of parallaxes has a problem that a luminance difference is caused between left and right eyes when viewed from places other than the strict front of the screen.

### SUMMARY OF THE INVENTION

The present invention has been made in view of these circumstances, and an object of thereof is to provide a stereoscopic image display apparatus and a stereoscopic image display method capable of preventing a luminance difference from being caused between left and right eyes irrespective of the observation position even if the viewing zone is wide and the number of parallaxes is large.

According to a first aspect of the present invention, there is provided a stereoscopic image display apparatus including: a display unit including pixels arranged in a matrix form in a longitudinal direction and a lateral direction; an optical plate installed so as to be opposed to the display unit and having linear optical openings prolonged in a longitudinal direction and arranged in a lateral direction; and a luminance compensation processing unit which, for each of elemental images associated with the optical openings, sets a brightness of an image displayed on a pixel located in a center of the elemental image smaller than a brightness of an image displayed on a pixel located in each of boundaries of the elemental image.

According to a second aspect of the present invention, there is provided a stereoscopic image display method using a stereoscopic image display apparatus comprising: a display unit including pixels arranged in a matrix form in a longitudinal direction and a lateral direction; and an optical plate installed so as to be opposed to the display unit and having linear optical openings prolonged in a longitudinal direction and arranged in a lateral direction, the method comprising: for each of elemental images associated with the optical openings, setting a brightness of an image displayed on a pixel located in a center of the elemental image smaller than a brightness of an image displayed on a pixel located in each of boundaries of the elemental image.

### BRIEF DESCRIPTION OF THE DRAWINGS

FIG. 1 is a lateral-direction section view of a stereoscopic image display apparatus according to an embodiment;

FIG. 2 is a diagram showing an example of a luminance profile every ideal parallax direction in a stereoscopic image display apparatus;

FIG. 3 is a diagram showing an example of a luminance profile every actual parallax direction in a conventional stereoscopic image display apparatus;

FIG. 4 is a diagram showing luminance distribution of a display unit in a stereoscopic image display apparatus according to an embodiment;

FIG. 5 is a flow chart showing an example of a luminance compensation processing procedure in a stereoscopic image display apparatus according to an embodiment;

FIG. 6 is a flow chart showing an example of a luminance compensation processing procedure in a stereoscopic image display apparatus according to an embodiment;

FIG. 7 is a block diagram showing a configuration of a luminance compensation processing unit in a stereoscopic image display apparatus according to an embodiment;

FIG. 8 is a diagram showing an example of a luminance/chromaticity compensation table using the parallax number as the index, in a stereoscopic image display apparatus;

FIG. 9 is a diagram showing an example of a luminance/chromaticity compensation table using the lens number as the index, in a stereoscopic image display apparatus;

FIG. 10 is an oblique view schematically showing a general configuration of a stereoscopic image display apparatus;

FIGS. 11A and 11B are oblique views schematically showing optical plates used in a stereoscopic image display apparatus;

FIG. 12(a) to (c) are exploded views schematically showing a general configuration of a stereoscopic image display apparatus; and

FIG. 13 is an oblique view schematically showing a partial configuration of a stereoscopic image display apparatus.

### DESCRIPTION OF THE EMBODIMENTS

Hereafter, embodiments of the present invention will be described with reference to the drawings.

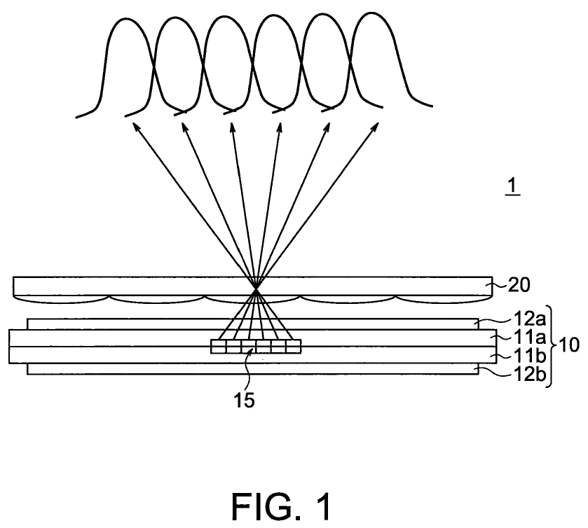

A stereoscopic image display apparatus according to an embodiment of the present invention is shown in FIG. 1. FIG. 1 is a lateral-direction section view of a stereoscopic image display apparatus 1 according to the present embodiment. A display unit 10 is a liquid crystal panel. There is a pixel plane between two glass substrates 11a and 11b. Sheet polarizers 12a and 12b are provided outside the glass substrates 11a and 11b. Each of pixels on the liquid crystal panel 10 is divided into sub-pixels respectively having three color components (for example, color components of R (red), G (green) and B (blue)) in the lateral direction. An optical plate 20 is a lenticular sheet. A pixel group corresponding to one lens of the lenticular sheet 20 is one elemental image 15. In FIG. 1, the elemental image 15 is a row of six sub-pixels. Light rays from the elemental image 15 are emitted in six directions through the lens of the lenticular sheet 20. Light in each direction has a spread to some extent. When images having the same brightness are displayed on respective pixels, distribution of luminance as a function of the angle (hereafter referred to as luminance profile) takes a shape like normal distribution as shown in FIG. 1. Some light rays among the light rays in these directions are incident on the right eye and the left eye. The viewer watches different video images with the left and right eyes, and recognize them as a stereoscopic video image.

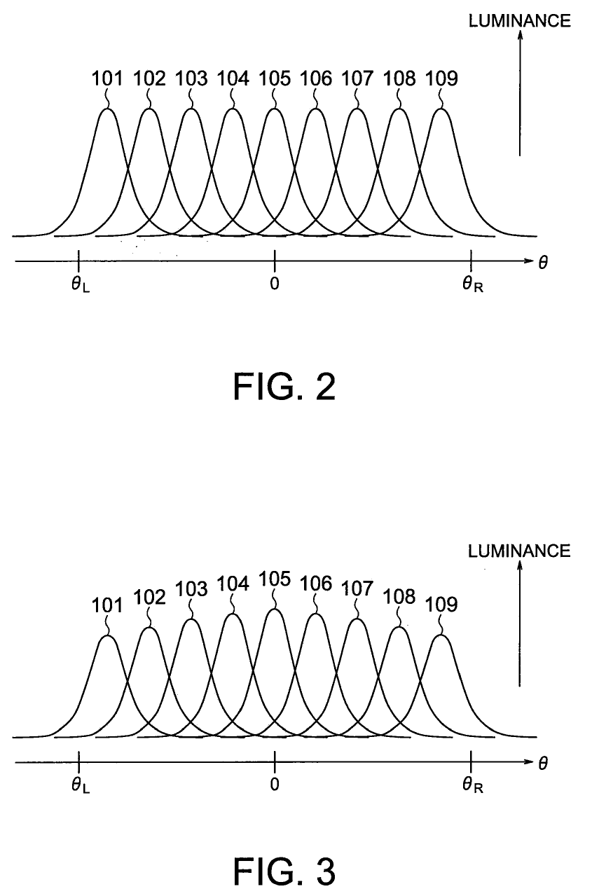

Examples of a luminance profile in every parallax direction of the stereoscopic video image display apparatus are shown in FIG. 2 and FIG. 3 with respect to light rays in nine directions in the case where the number of parallaxes is nine. In FIG. 2 and FIG. 3, the abscissa axis indicates the angle and the ordinate axis indicates the luminance. If luminance profiles corresponding to respective parallaxes coincide with each other as in the ideal case shown in FIG. 2, no problem is posed. As a matter of fact, however, the luminance tends to become higher as the parallax number approaches that at the center (in a light ray from a pixel located near the center of the elemental image) and the luminance tends to become lower as the parallax number goes away from that at the center (in a light ray from a pixel located near a boundary of the elemental image). The tendency is caused by viewing angle characteristics of a display unit 10 such as a liquid crystal panel, a difference in an incidence angle to a lens, and a lens aberration. The tendency becomes remarkable as the viewing angle becomes wide and the number of parallaxes becomes large. If the viewer views from the front of the screen, there is no luminance difference because, for example, light rays 104 and 106 are incident on the left and right eyes, respectively. If the viewer views from a place other than the front, then, for example, light rays 102 and 104 are incident on the left and right eyes and consequently a luminance difference is caused. The luminance difference between the left and right eyes brings about a sense of incongruity in recognition of a stereoscopic image in some cases. In FIG. 2 and FIG. 3, θ_{R} denotes a right-side viewing zone boundary angle and θ_{L} denotes a left-side viewing zone boundary angle.

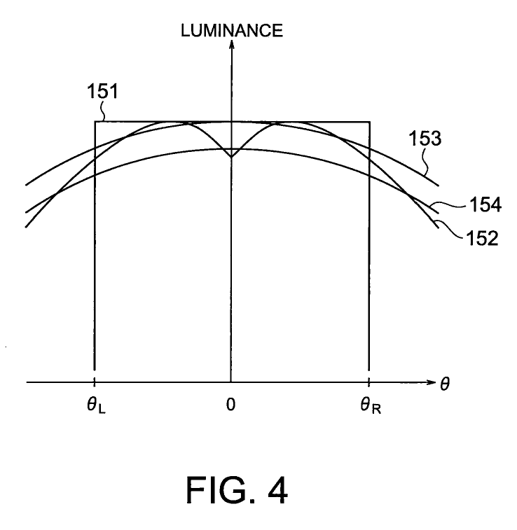

An example of luminance distribution of a display unit (liquid crystal panel) in the stereoscopic image display apparatus according to the present embodiment is shown in FIG. 4. In FIG. 4, the abscissa axis indicates the angle and the ordinate axis indicates the luminance. Reference numeral 151 denotes ideal luminance distribution for stereoscopic display, which becomes constant in the range of the viewing angle (at angles in the range between the right-side viewing zone boundary angle θ_{R} and the left-side viewing zone boundary angle θ_{L}). However, it is difficult to realize such luminance distribution. Reference numeral 152 denotes an example of luminance distribution suitable for stereoscopic display. The luminance distribution 152 is distribution which has little luminance difference between positions of the left and right eyes although there is dependence upon the angle. As for such luminance distribution, characteristic of some extent can be realized by conducting a design with due regard to the symmetry in a liquid crystal panel provided with a directionality changeover backlight and time-averaged in luminance distribution. However, it is difficult to obtain sufficient characteristics. Reference numeral 153 denotes luminance distribution of a standard liquid crystal panel. Reference numeral 154 denotes luminance distribution at pixels in the elemental image central part obtained when correction processing according to the present embodiment is conducted. Luminance distribution at pixels in elemental image boundary parts obtained when correction processing according to the present embodiment is conducted becomes the distribution denoted by the reference numeral 153. Pixels between the central part and the boundary parts are set so as to change gradually between the luminance distribution 154 and the luminance distribution 153.

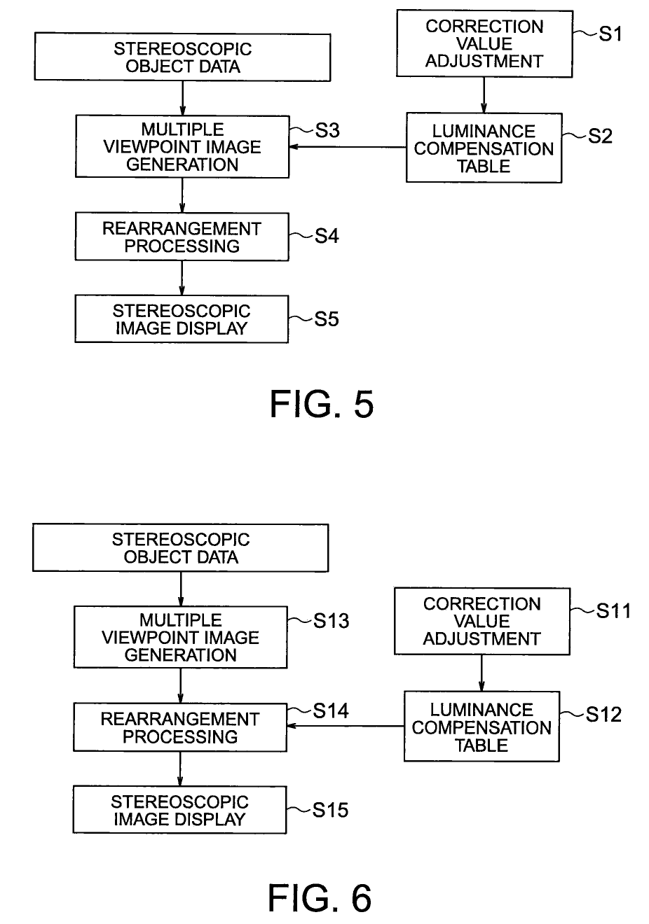

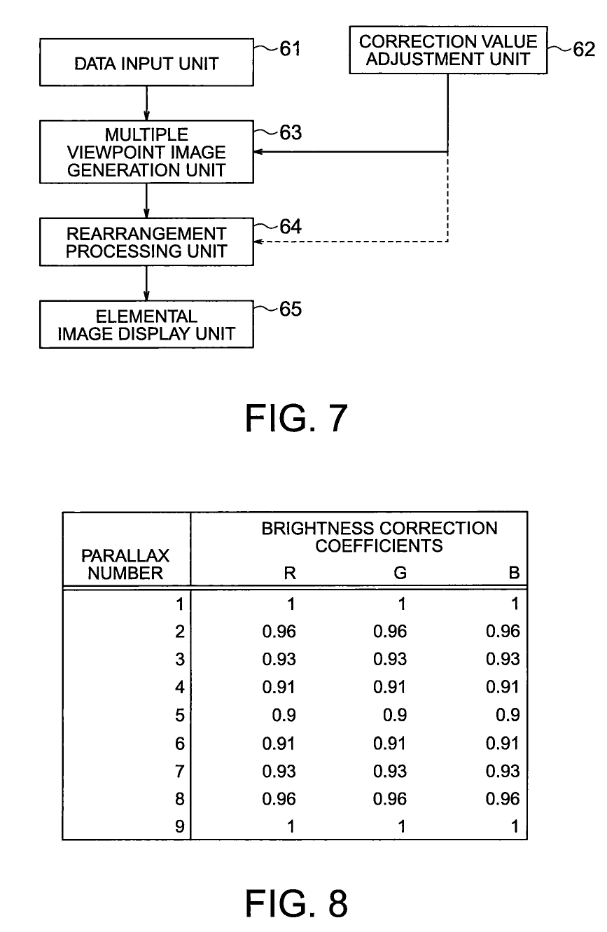

A processing procedure of luminance compensation processing in the stereoscopic image display apparatus and display method according to the present embodiment is shown in FIGS. 5 and 6, and its block diagram is shown in FIG. 7. FIG. 5 shows luminance compensation processing in the stereoscopic display method including real time processing of computer graphics (CG). First, luminance correction value adjustment is conducted previously (step S1) and its result is stored in a luminance compensation table (step S2). Subsequently, in a stage (step S3) for generating a multiple viewpoint image from stereoscopic object data, the range of image brightness is changed according to the luminance compensation table every viewpoint image and rearrangement processing is conducted in an interleave form to conduct conversion into an elemental image array (step S4). And image data converted into the elemental image array is displayed in the display unit 10 (step S5). Adjustment of correction coefficients in the luminance compensation table may be conducted by using a control panel screen in software or an adjustment knob in hardware.

FIG. 6 is a flow chart showing luminance compensation processing conducted when displaying a stereoscopic video image on the basis of an existing multiple viewpoint image. In this case as well, luminance correction value adjustment is conducted previously (step S11), and its result is stored in a luminance compensation table (step S12). Subsequently, a multiple viewpoint image is generated on the basis of stereoscopic object data (step S13). Thereafter, the range of image brightness is changed by conducting filter processing on the basis of the luminance compensation table for each viewpoint image, and rearrangement processing is conducted in an interleave form to conduct conversion into an elemental image array (step S14). And image data converted into the elemental image array is displayed in the display unit 10 (step S15). The luminance compensation processing shown in FIG. 6 is suitable for the case where a stereoscopic video image is displayed from an actually taken image or a CG image already generated and stored.

FIG. 7 is a block diagram showing a configuration of a luminance compensation processing unit in a stereoscopic image display apparatus according to the present embodiment. The luminance compensation processing unit includes a data input unit 61 which reads out data including stereoscopic information such as object data, a multiple viewpoint image generation unit 63 which generates a multiple viewpoint image on the basis of data, a rearrangement processing unit 64 which rearranges the multiple viewpoint image in the interleave form, and a display unit 65 which displays an elemental image array generated by the rearrangement. A correction value adjustment unit 62 is connected to the multiple viewpoint image generation unit 63 when conducting the luminance compensation processing shown in FIG. 5. The correction value adjustment unit 62 is connected to the rearrangement processing unit 64 when conducting the luminance compensation processing shown in FIG. 6.

An example of a luminance/chromaticity compensation table using the parallax number as the index, in the stereoscopic image display apparatus according to the present embodiment is shown in FIG. 8. Setting is conducted so as to minimize correction coefficients for a central parallax number 5 and maximize correction coefficients for parallax numbers 1 and 9 at both ends. In other words, a brightness of an image displayed on a pixel located in the center of the elemental image is set so as to become smaller than a brightness of an image displayed on a pixel located in the boundaries of the elemental image and so as to decrease the range of brightness from the center of the elemental image toward the boundaries of the elemental image. The peak luminance of the luminance profile observed through a lens is made smaller by multiplying the brightness level by the correction coefficients. If means for adjusting the compensation table by using software or the like is provided, brightness adjustment is possible. If correction coefficients are set independently for respective color components, not only the luminance difference but also the chromaticity difference can be compensated.

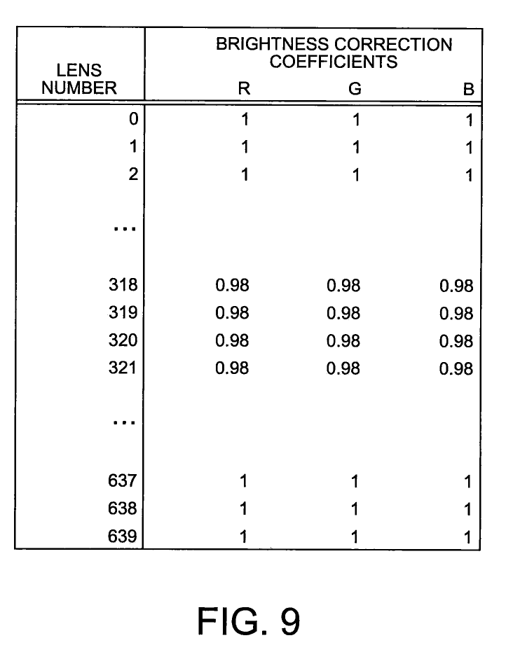

An example of a luminance/chromaticity compensation table using the lens number as the index, in the stereoscopic image display apparatus according to the present embodiment is shown in FIG. 9. In this example, not only the compensation using the parallax number as the index in the example shown in FIG. 8 but also compensation using the lens number as the index is conducted. As a result, luminance distribution in the screen recognized by the viewer depending upon the angle of view (the screen looks dark as the end is approached) can be eliminated. In other words, a brightness of an image displayed on a pixel located on a center of each elemental image in the center of the display unit 10 is set so as to become smaller than a brightness of an image displayed on a pixel located in the center of each elemental image at the left and right ends of the display unit 10. If means for adjusting the compensation table by using software or the like is provided, brightness adjustment is possible. If correction coefficients are set independently for respective color components, not only the luminance difference but also the chromaticity difference can be compensated.

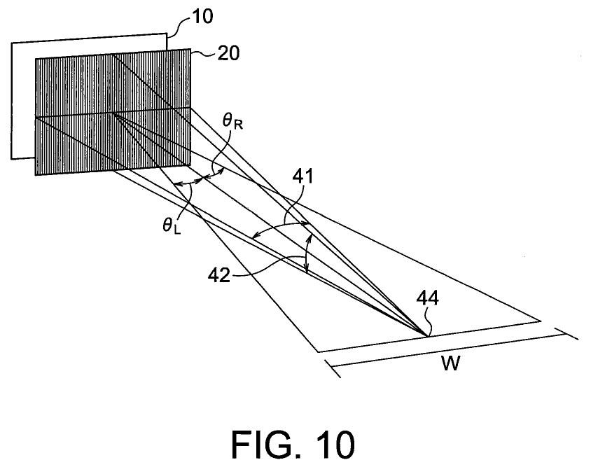

Stereoscopic image display using the one-dimensional IP scheme or the multiview scheme will now be described with reference to FIGS. 10 to 13.

FIG. 10 is an oblique view schematically showing a general configuration of the stereoscopic image display apparatus. The display unit 10 is a high definition liquid crystal panel module of a mosaic color filter arrangement having an opening shape described earlier and sub-pixels arranged in a matrix form. The color filter arrangement may be longitudinal stripes or lateral stripes. The display unit may be a plasma display panel, an organic EL display panel, a field emission type display panel, or any kind as long as the shape of the sub-pixel opening and the color arrangement satisfy the above-described condition. An optical plate 20 is provided so as to be opposed to the display unit 10. The position of the supposed viewer is located near a position 44 on a viewing distance and in a range of a viewing zone width W. The viewer can observe a stereoscopic video image near the front and back of the optical plate 20 in the range of a horizontal angle of view 41 and a vertical angle of view 42. The viewing zone width W corresponds to the right-side viewing zone boundary angle θ_{R} and the left-side viewing zone boundary angle θ_{L}.

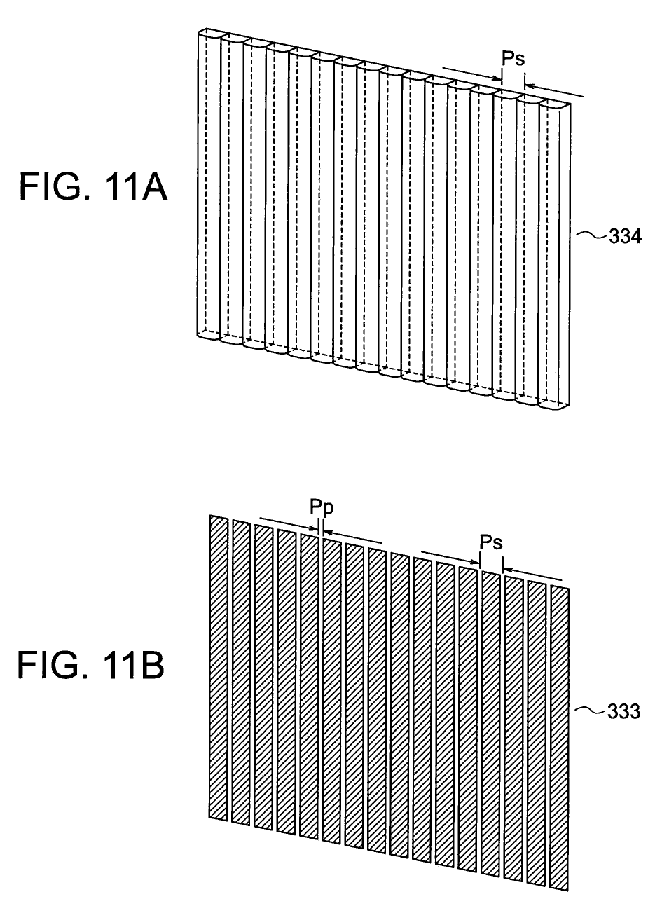

FIG. 11A is an oblique view of a lenticular sheet 334 serving as the optical plate 20. FIG. 11B is an oblique view of a slit array 333 serving as the optical plate 20. A horizontal pitch Ps is a pitch in a direction which coincides with the pixel row direction of the display unit. The extension direction of the lenses or slits need not always be the same as the vertical direction (the longitudinal direction, i.e., the pixel column direction), but may be an oblique direction.

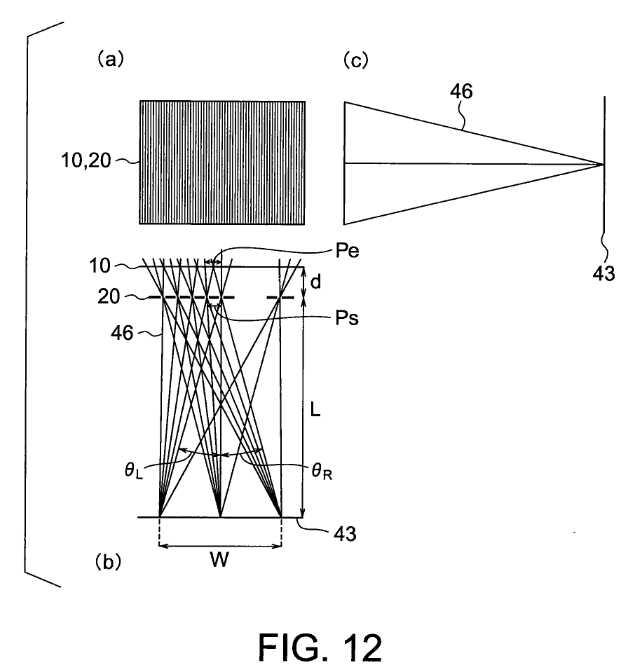

FIG. 12(a), (b) and (c) are exploded views schematically showing a light ray reproduction range in the vertical plane and the horizontal plane using the display unit in the stereoscopic image display apparatus shown in FIG. 10 as reference.

FIG. 12(a) is a front view of the display unit 10 and the optical plate 20. FIG. 12(b) is a plan view showing an image disposition of the stereoscopic image display apparatus. FIG. 12(c) is a side view of the stereoscopic image display apparatus. As shown in FIGS. 10 to 11B, the stereoscopic image display apparatus includes the display unit 10 such as the liquid crystal display panel and the optical plate 20 having an optical opening.

If a viewing distance L between the optical plate 20 and a viewing distance plane 43, a horizontal pitch Ps of the optical plate 20, and a gap d between the optical plate 20 and a pixel plane are determined in FIG. 12(a), (b) and (c), then a horizontal pitch Pe of the elemental image is determined by spacing obtained by projecting a center of an aperture (or a lens principal point) on the display screen from a viewpoint on the viewing distance plane 43. A reference numeral 46 denotes a line which couples the viewpoint position to the center of each aperture, and the viewing zone width W is determined from the condition that elemental images do not overlap on the display plane of the display apparatus. In the case of the one-dimensional IP scheme under the condition that it has a set of parallel light rays, the average value of the horizontal pitch of elemental image is slightly larger than an integer times of the horizontal pitch of pixels, and the horizontal pitch of the optical plate 20 is equal to an integer times of the horizontal pitch of pixels. In the case of the multiview scheme, the horizontal pitch of the elemental images is equal to an integer times of the horizontal pitch of the pixels, and the horizontal pitch of the optical plate 20 is slightly smaller than an integer times of the horizontal pitch of pixels.

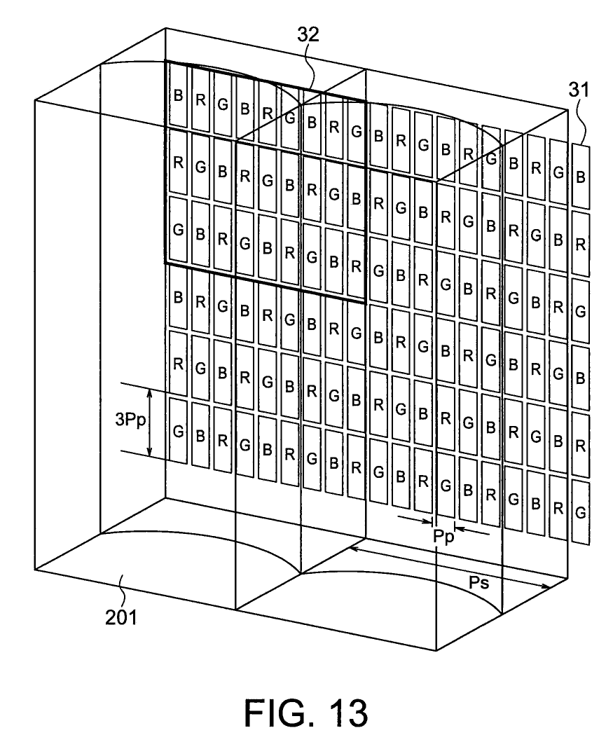

FIG. 13 is an oblique view schematically showing a partial configuration of the stereoscopic image display apparatus according to the present embodiment. The case where a cylindrical lens array (lenticular sheet) 201 is disposed in front of a planar display unit such as a liquid crystal panel is shown. As shown in FIG. 13, sub-pixels 31 having an aspect ratio 3:1 are disposed in a straight line manner in each of the lateral direction and the longitudinal direction so as to form a matrix on the display plane of the display apparatus. The sub-pixels 31 are arranged so as to make red (R), green (G) and blue (B) sub-pixels appear by turns in the row direction and the column direction. This color arrangement is generally called mosaic arrangement. It is supposed that the opening of the sub-pixel 31 takes a shape shown in FIG. 13. Sub-pixels 31 in nine columns by three rows constitute one stereoscopic display pixel 32 (indicated in a black frame). In such a structure of the display unit, the stereoscopic display pixel 32 has 27 sub-pixels. Therefore, stereoscopic image display (stereoscopic image display) which gives nine parallaxes in the horizontal direction becomes possible.

In the stereoscopic image display apparatus having a wide viewing zone and a large number of parallaxes, the luminance difference between left and right eyes is eliminated from any viewing position and easiness to view is improved by the method heretofore described.

The present invention is not restricted to the embodiment as it is. In the implementation stage, components can be modified and implemented without departing from the spirit of the invention.

Furthermore, various inventions can be formed by suitably combining a plurality of components disclosed in the embodiment. For example, some components may be removed from all components described in the embodiment. In addition, components striding over different embodiments may be suitably combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A stereoscopic image display apparatus comprising:
a display unit including pixels arranged in a matrix form in a longitudinal direction and a lateral direction;
an optical plate installed so as to be opposed to the display unit and having linear optical openings prolonged in a longitudinal direction and arranged in a lateral direction; and
a luminance compensation processing unit which, for each of elemental images associated with the optical openings, sets a brightness of an image displayed on a pixel located in a center of the elemental images smaller than a brightness of an image displayed on a pixel located in each of boundaries of the elemental images.

2. The apparatus according to claim 1, wherein the brightness decreases from the boundaries of the elemental images toward the center of the elemental images.

3. The apparatus according to claim 1, wherein a brightness of an image displayed on a pixel located on a center of each elemental images in a center of the display unit is set so as to become smaller than a brightness of an image displayed on a pixel located in a center of each elemental images at left and right ends of the display unit.

4. The apparatus according to claim 1, further comprising an adjustment unit which adjusts the brightness.

5. The apparatus according to claim 1, wherein an increase/decrease of the brightness differs from color component pixel to color component pixel.

6. A stereoscopic image display method using a stereoscopic image display apparatus comprising: a display unit including pixels arranged in a matrix form in a longitudinal direction and a lateral direction; and an optical plate installed so as to be opposed to the display unit and having linear optical openings prolonged in a longitudinal direction and arranged in a lateral direction,
the method comprising:
for each of elemental images associated with the optical openings, setting a brightness of an image displayed on a pixel located in a center of the elemental images smaller than a brightness of an image displayed on a pixel located in each of boundaries of the elemental images.
